(19) United States
(12) Patent Application Publication
(10) Pub. No.: US 2016/0117533 A1
(43) Pub. Date: Apr. 28, 2016

(54) ELECTRONIC DEVICE AND BACK COVER THEREOF

(71) Applicant: ASUSTeK COMPUTER INC., Taipei City (TW)

(72) Inventors: Tsung-Yi Lin, Taipei City (TW); Shang-Yu Hung, Taipei City (TW); Shiang-Cong Chen, Taipei City (TW); Hung-Po Chen, Taipei City (TW)

(21) Appl. No.: 14/884,768

(22) Filed: Oct. 16, 2015

Related U.S. Application Data
(60) Provisional application No. 62/069,332, filed on Oct. 28, 2014.

(30) Foreign Application Priority Data
Sep. 4, 2015 (TW) 104129279

(51) Int. Cl. G06K 7/10; G06K 19/077

(52) U.S. Cl. CPC G06K 7/10237; G06K 19/07739

(57) ABSTRACT

An electronic device and a back cover thereof are provided. The electronic device comprises a body and the back cover. The back cover includes a near field communication chip, a controller, an antenna and a first security terminal. The body includes a security chip and a second security terminal. The controller is coupled to a first security terminal, and the controller is coupled to an antenna via the NFC chip. The controller is communicated with a body of the electronic device via the first security terminal.

### CROSS-REFERENCE TO RELATED APPLICATION

This application claims the priority benefit of U.S. provisional application Ser. No. 62/069,332, filed on Oct. 28, 2014 and Taiwan application serial No. 104129279, filed on Sep. 4, 2015. The entirety of the each of the above-mentioned patent applications is hereby incorporated by reference herein and made a part of this specification.

### BACKGROUND OF THE INVENTION

1. Field of the Invention

The invention relates to an electronic device and, more specifically, to an electronic device with a NFC (Near Field Communication) function.

2. Description of the Related Art

NFC technology is a near-field high frequency wireless communication technology, which is derived from non-contact RFID (Radio Frequency Identification) and interconnection technology. NFC technology allows two electronic devices to establish a point-to-point connection and communication with each other when they get close or contact with each other, and data can be wirelessly transmitted and exchanged.

NFC technology facilitates data storage, management and transmission greatly. When the consumer electronic devices, such as a smart phone, a watch, a camera, a portable game machine or a notebook, equipped with NFC modules, it would expand the functionalities for identity recognition, such as data exchange and pay transaction functions.

To provide a NFC function for an electronic device without a NFC chip, a replaceable accessory with a NFC chip is usually applied to the electronic device. However, in consideration of the security in data transmission, a security chip needs to be built in the replaceable accessory. Therefore, the cost is high. In addition, the replaceable accessory with the security chip is thicker and it is rather inconvenient for using.

### BRIEF SUMMARY OF THE INVENTION

A back cover adapted to an electronic device is provided. The back cover includes a NFC chip, a controller, an antenna and a first security terminal. The antenna is coupled to the controller via the NFC chip. The controller is coupled to the first security terminal. The controller is communicated with a body of the electronic device via the first security terminal.

An electronic device including a body and a back cover is provided. The body includes a security chip and a second security terminal. The back cover includes a NFC chip, a controller, an antenna and a first security terminal. The antenna is coupled to the controller via the NFC chip. The controller is coupled to the first security terminal. The controller is communicated with the security chip via the first security terminal and the second security terminal.

In sum, since the controller on the back cover is communicated with the security chip of the electronic device via the security terminal, the cost of the back cover without a security chip is therefore reduced.

### BRIEF DESCRIPTION OF THE DRAWINGS

These and other features, aspects and advantages of the invention will become better understood with regard to the following description, appended claims, and accompanying drawings.

FIG. 1 is a schematic diagram showing assembly of an electronic device in an embodiment.

FIG. 2 is a circuit diagram of the back cover in FIG. 1.

FIG. 3A to 3C shows terminals in embodiments, respectively.

### DETAILED DESCRIPTION OF THE EMBODIMENTS

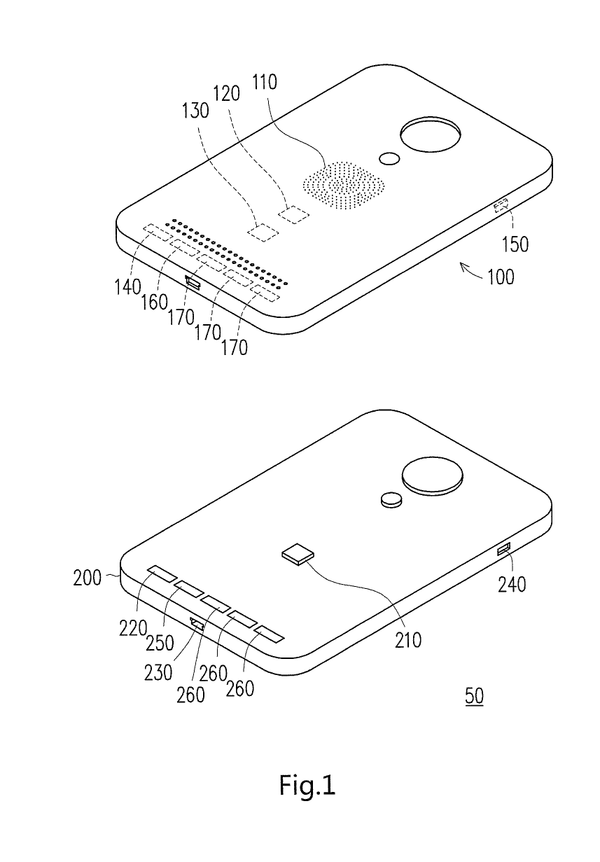

FIG. 1 is a schematic diagram showing assembly of an electronic device in an embodiment. As shown in FIG. 1, an electronic device 50 in the embodiment includes a body 200 and a back cover 100. The back cover 100 includes a NFC chip 120, a controller 130, an antenna 110 and a first security terminal 140. The body 200 includes a security chip 210 and a second security terminal 220. The back cover 100 is adapted to be mounted to the body 200 of the electronic device 50. In embodiments, the electronic device 50 is a smart phone or a tablet PC, which is not limited herein. In an embodiment, the NFC chip 120, the controller 130 and the antenna 110 are disposed in the back cover 100 via insert injection molding, the first security terminal 140 is also formed in the back cover 100 via the insert injection molding, and part of the first security terminal 140 is exposed out of the back cover 100, which is not limited herein.

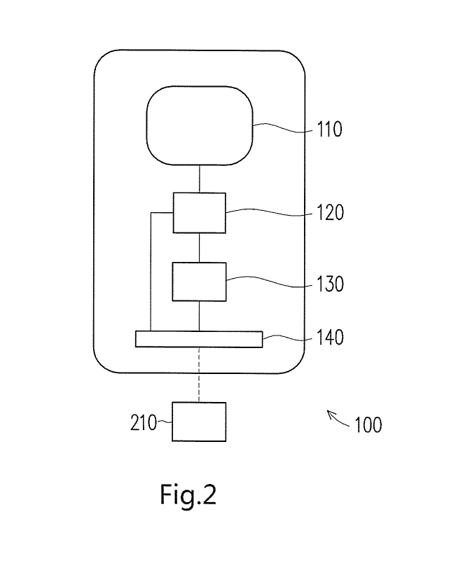

FIG. 2 is a circuit diagram of the back cover in FIG. 1. As shown in FIGS. 1 and 2, the antenna 110 is coupled to the controller 130 via the NFC chip 120. The first security terminal 140 is coupled to the controller 130. The controller 130 is communicated with the security chip 210 via the first security terminal 140 and the second security terminal 220. After the controller 130 of the back cover 100 is communicated with the security chip 210 of the body 200 and security authentication therebetween is completed, the NFC function is enabled to have data transmission with other devices via the NFC chip 120 and the antenna 110 to perform identity recognition, data exchange, pay transaction and other functions.

In the above embodiment, the security chip 210 is not disposed at the back cover 100, the cost of the back cover 100 is reduced, and the purchase intention is improved. Furthermore, in an embodiment, since the body 200 of the electronic device 50 in the market is already equipped with a security chip 210, the security chip 210 does not need to be integrated to the back cover 100. In the embodiment, security data exchange between the back cover 100 and the body 200 is performed via the first security terminal 140 and the second security terminal 220 instead of via the USB port 230 of the body 200. Consequently, the USB port 230 of the body 200 is available for power charging, data transmitting or other functions. Moreover, the NFC chip 120 and the antenna 110 are disposed at the back cover 100 instead of at the body 200, which reduces the cost of the body 200. As a result, user can choose a back cover 100 with or without a NFC chip 120 according to requirements, and the purchase intention of users is improved.

The back cover 100 includes a first connecting unit 150, and the body 200 includes a second connecting unit 240. The first connecting unit 150 is configured corresponding to the second connecting unit 240. The first connecting unit 150 of the back cover 100 is connected with the second connecting unit 240 of the body 200 to assemble the back cover 100 and the body 200 together. In embodiments, the first connecting unit 150 and the second connecting unit 240 are a tenon joint, a hook, a magnetic element or a screw-locking component, the number and configuration of the first connecting unit 150 and the second connecting unit 240 are not limited herein.

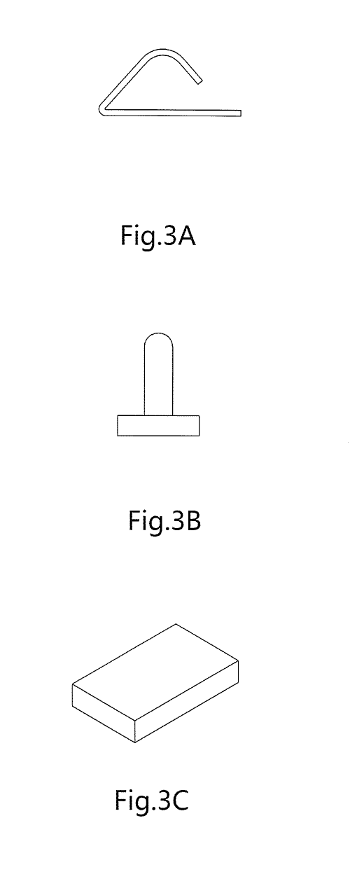

In an embodiment, the antenna 110 is a loop antenna made of a conductive metal such as copper, aluminum, tin, gold and silver. In the embodiment, the back cover 100 further includes a first power supply terminal 160, and the body 200 further includes a second power supply terminal 250. The first power supply terminal 160 is coupled to the controller 130. The controller 130 is charged from the body 200 of the electronic device 50 via the first power supply terminal 160 and the second power supply terminal 250. In an embodiment, the body 200 further includes multiple terminals 260 while the back cover 100 includes multiple corresponding terminals 170. The terminals 260 are coupled to the terminals 170 correspondingly to provide a detection function or ground connection, which is not limited herein. In embodiments, the first security terminal 140, the second security terminal 220, the first power supply terminal 160, the second power supply terminal 250 is a spring blade as shown in FIG. 3A, a needle member as shown in FIG. 3B, a sheet in FIG. 3 or terminals in other forms.

In sum, a NFC chip and a security terminal are configured at the back cover of the electronic device, a NFC function can be expanded at the back cover according to the requirement, and the security terminal on the back cover is communicated with the security chip of the body of the electronic device when physical contacted, and thus the security in communication is enhanced.

Although the invention has been disclosed with reference to certain embodiments thereof, the disclosure is not for limiting the scope. Persons having ordinary skill in the art may make various modifications and changes without departing from the scope of the invention. Therefore, the scope of the appended claims should not be limited to the description of the embodiments described above.

What is claimed is:

1. A back cover, adapted to an electronic device, the back cover comprising:
a NFC (Near Field Communication) chip;
a controller;
an antenna coupled to the controller via the NFC chip; and
a first security terminal coupled to the controller, wherein the controller is communicated with a body of the electronic device via the first security terminal.

2. The back cover according to claim 1, wherein the NFC chip is coupled to the first security terminal.

3. The back cover according to claim 1, wherein the first security terminal is a spring blade, a needle member or a sheet.

4. The back cover according to claim 1, further comprising:
a first connecting unit for connecting with a second connecting unit at the body of the electronic device.

5. The back cover according to claim 1, further comprising:
a first power supply terminal coupled to the controller, wherein the controller is charged from the body via the first power supply terminal when the back cover is combined with the body of the electronic device.

6. An electronic device, comprising:
a body including a security chip and a second security terminal; and
a back cover including a NFC chip, a controller, an antenna and a first security terminal, wherein the antenna is coupled to the controller via the NFC chip,
wherein the first security terminal is coupled to the controller, and the controller is communicated with the security chip via the first security terminal and the second security terminal.

7. The electronic device according to claim 6, wherein the NFC chip is coupled to the first security terminal.

8. The electronic device according to claim 6, wherein the first security terminal is a spring blade, a needle member or a sheet.

9. The electronic device according to claim 6, wherein the back cover further includes a first connecting unit, the body further includes a second connecting unit, and the back cover is connected with a second connecting unit of the body via the first connecting unit.

10. The electronic device according to claim 6, wherein the body further includes a second power supply terminal, the back cover further includes a first power supply terminal coupled to the controller, and the controller is charged from the body via the first power supply terminal and the second power supply terminal when the back cover is combined with the body.
